(19) United States
(12) Patent Application Publication
(10) Pub. No.: US 2020/0377096 A1
(43) Pub. Date: Dec. 3, 2020

(54) SYSTEM AND METHOD FOR CONTROLLING CREEP RUNNING OF VEHICLE

(71) Applicants: HYUNDAI MOTOR COMPANY, Seoul (KR); KIA MOTORS CORPORATION, Seoul (KR)

(72) Inventor: Jaehyung Park, Seoul (KR)

(21) Appl. No.: 16/699,550

(22) Filed: Nov. 29, 2019

(30) Foreign Application Priority Data
May 28, 2019 (KR) 10-2019-0062411

(51) Int. Cl. B60W 30/18; B60W 40/076; B60W 40/107; B60W 40/105

(52) U.S. Cl. CPC B60W 30/18063; B60W 40/076; B60W 2520/28; B60W 40/105; B60W 40/107

(57) ABSTRACT

An exemplary system for controlling creep running of a vehicle equipped with an engine and a transmission includes, a driving information detection unit detecting driving information of the vehicle, an engine controller for controlling an output torque of the engine, and a vehicle control unit controlling the engine controller to output a basic creep driving torque, and when the vehicle is on a sloped road of more than a predetermined inclination, to further output a first additional driving torque corresponding to an inclination of the sloped road.

### CROSS-REFERENCE TO RELATED APPLICATION

This application claims priority to and the benefit of Korean Patent Application No. 10-2019-0062411 filed in the Korean Intellectual Property Office on May 28, 2019, the entire contents of which are incorporated herein by reference.

### BACKGROUND

### (a) Field

The present disclosure relates to a system for controlling creep running of a vehicle and a method thereof.

### (b) Description of the Related Art

Generally, when an automatic transmission vehicle is to be parked on a flat ground, it can be safely and easily parked at low speed by using creep running in a forward (D) and/or reverse (R) range. The creep running means a state in which the vehicle travels at a low speed in the forward (D) or reverse (R) range when the brake pedal is OFF while the driver does not press the accelerator pedal.

However, since the conventional creep running control method does not consider the inclination of the road, it is difficult to take an advantage of the creep running of the vehicle when the vehicle is moving on the inclined road. In more detail, the vehicle may not move or may slide in the opposite direction depending on the inclination, according to a conventional method that does not take into account of the inclination of the road.

For example, FIG. 1 shows a conventional creep running state in a reverse (R) range on a sloped road.

Referring to FIG. 1(A), when the vehicle travels backward in the reverse (R) range on the flat ground, the vehicle is moved backward at a low speed according to a predetermined creep torque of the engine.

However, while the driving force in the creep running state of the vehicle is constant, the magnitude of the gravity component increases according to the inclination of the road, and accordingly the result of the creep running may become different.

For example, when the vehicle is parked on a sloped road, the vehicle may be stationary as shown in FIG. 1(B) or may move downward on the sloped road as shown in FIG. 1(C) depending on the inclination of the road even if the creeping torque is applied.

As a result, there is a problem that the driver has to repeatedly operate the accelerator pedal and the brake pedal on the sloped road, and when a driver is not well-trained, the driver may feel uneasy in parking due.

The above information disclosed in this Background section is only for enhancement of understanding of the background and therefore it may contain information that does not form the prior art that is already known in this country to a person of ordinary skill in the art.

### SUMMARY

An embodiment of the present disclosure is to provide a system for controlling creep running of a vehicle and a method thereof that changes engine output according to an inclination, so that low-speed creep running of a vehicle may be maintained the same as on a flat ground, irrespective of road inclination.

An exemplary system is provided for controlling creep running of a vehicle equipped with an engine and a transmission. The system may include, a driving information detection unit detecting driving information of the vehicle, an engine controller for controlling an output torque of the engine in response to a control signal, and a vehicle control unit. The vehicle control unit may control the engine controller to output a basic creep driving torque, and when the vehicle is on a sloped road of more than a predetermined inclination, to further output a first additional driving torque corresponding to an inclination of the sloped road.

The driving information detection unit may include a vehicle speed sensor, an accelerator pedal sensor (APS), a brake pedal sensor (BPS), a longitudinal acceleration sensor, a wheel speed sensor, and a transmission position sensor (TPS).

The engine controller may be configured to control the engine to output the basic creep driving torque and to further output the first additional driving torque in response to the control signal.

The vehicle control unit may calculate the first additional driving torque corresponding to the inclination of the sloped road when the transmission is in a reverse range while the vehicle is on a downward slope or when the transmission is in a forward range on an upward slope.

The vehicle control unit may estimate the road inclination based on a longitudinal acceleration sensor value and a differentiation of a wheel speed sensor value.

The vehicle control unit may estimate the road inclination by calculating a wheel acceleration by the differentiation of a wheel speed sensor value, subtracting the wheel acceleration from the longitudinal acceleration sensor value, and then taking an inverse trigonometric function of the subtracted value.

The vehicle control unit may calculate a minimum creep driving torque as a sum of the basic creep driving torque and the first additional driving torque corresponding to the road inclination, and controls the engine controller to output a final creep driving torque of at least the minimum creep driving torque.

The minimum creep driving torque may be retrieved from a predetermined control map preset with respect to the road inclination based on a basic vehicle mass.

When a target creep running wheel speed is not achieved by the minimum creep driving torque, the vehicle control unit may increase the final creep driving torque by feeding back a second additional driving torque.

The vehicle control unit may calculate a second additional driving torque to compensate a gravitational effect of a vehicle mass increase on the sloped road, and may add the second additional driving torque to the minimum creep driving torque to form the final creep driving torque.

An exemplary method is for controlling creep running of a vehicle equipped with an engine and a transmission. The method may include, determining a low speed condition of a vehicle speed being less than a threshold vehicle speed, determining a road inclination condition of whether a road inclination is above a threshold inclination, determining a transmission position condition of whether the vehicle is in the reverse (R) range on a downward slope or whether the vehicle is in the forward (D) range in an upward slope, determining a pedal condition of whether an off-signal is received from both an accelerator pedal sensor (APS) and a brake pedal sensor (BPS), calculating a minimum creep driving torque as a sum of a basic creep driving torque for creep driving of the vehicle on a flat road and a first additional driving torque corresponding to the road inclination, in the case that the low speed condition, the road inclination condition, the transmission position condition, and the pedal condition are met, and controlling the engine to output a final creep driving torque that is at least the minimum creep driving torque.

The road inclination may be estimated based on a longitudinal acceleration sensor value and a differentiation of a wheel speed sensor value.

When the transmission position condition is not satisfied, the creep running of the vehicle may be controlled by the basic creep driving torque.

The calculation of the minimum creep driving torque may be performed by retrieving a value corresponding to the road inclination from a predetermined control map.

The exemplary method may further include, determining whether a target creep wheel speed is achieved by the minimum creep driving torque, and maintaining the minimum creep driving torque as the final creep driving torque, when the target creep wheel speed is achieved by the minimum creep driving torque.

The exemplary method may further include, determining whether a target creep wheel speed is achieved by the minimum creep driving torque, and controlling the final creep driving torque, when the target creep wheel speed is not achieved, by feeding back a second additional driving torque to the minimum creep driving torque, until the target creep wheel speed is not achieved.

In a further embodiment, an exemplary system is provided for controlling creep running of a vehicle equipped with an engine, a motor, and a transmission. The exemplary system may include, a driving information detection unit detecting driving information of the vehicle, an engine controller for controlling an output torque of the engine, a motor controller for controlling an output torque of the motor, and a vehicle control unit. The vehicle control unit may control the engine controller to output a basic creep driving torque, and when the vehicle is on a sloped road of more than a predetermined inclination, may control the motor controller to output a first additional driving torque corresponding to an inclination of the sloped road.

The vehicle control unit may control the engine controller and the motor controller to form a final creep driving torque formed as a sum of the basic creep driving torque of the engine, the first additional driving torque of the motor taking into account of the road inclination, and a second additional driving torque of the motor taking into account of a vehicle mass variation.

In a further embodiment, an exemplary system is provided for controlling creep running of a vehicle equipped with a motor and a transmission. The exemplary system may include, a driving information detection unit detecting driving information of the vehicle, a motor controller for controlling an output torque of the motor, and a vehicle control unit. The vehicle control unit may control the motor controller to output a basic creep driving torque, and when the vehicle is on a sloped road of more than a predetermined inclination, to further output a first additional driving torque corresponding to an inclination of the sloped road.

The vehicle control unit may control the motor controller to output a final creep driving torque formed as a sum of the basic creep driving torque of the motor, the first additional driving torque of the motor taking into account of the road inclination, and a second additional driving torque taking into account of a vehicle mass variation.

According to the embodiment of the present disclosure, even if the vehicle is located on a sloped road, a low speed creep running similar to the case that the vehicle is on a flat road may be achieved.

Since the vehicle may show a creep running on the sloped road similarly to the flat road, convenience in driving the vehicle in a low speed may be achieved, e.g., in the case of moving the vehicle back and forth in parking.

### BRIEF DESCRIPTION OF THE DRAWINGS

FIG. 1 shows exemplary creep running state in a reverse (R) range on a slope according to a conventional method.

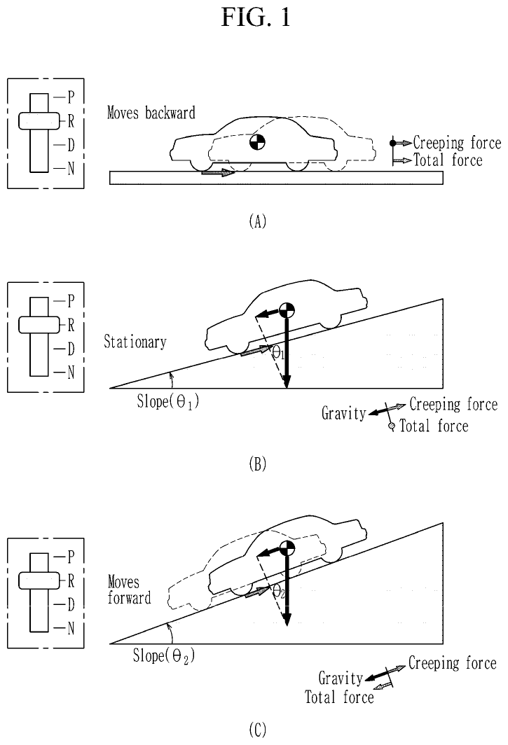

FIG. 2 is a schematic diagram of a system for controlling creep running of a vehicle according to a first exemplary embodiment of the present disclosure.

FIG. 3 schematically illustrates controlling creep running of a vehicle on a sloped road according to a first exemplary embodiment of the present disclosure.

FIG. 4 illustrates a method for estimating a slope according to a first exemplary embodiment of the present disclosure.

FIG. 5 is a flowchart showing a method for controlling creep running of a vehicle according to a first exemplary embodiment of the present disclosure.

FIG. 6 is a schematic diagram of a system for controlling creep running of a vehicle according to a second exemplary embodiment of the present disclosure.

FIG. 7 shows a schematic representation of the creep running control system of a vehicle according to a third exemplary embodiment of the present disclosure.

### DETAILED DESCRIPTION OF THE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising”, will be understood to imply the inclusion of stated elements but not the exclusion of any other elements. In addition, the terms “-er”, “-or” and “module” described in the specification mean units for processing at least one function and operation and can be implemented by hardware components or software components and combinations thereof.

A component referred to as a controller or a control unit in the present disclosure may be embodied as an electronic control unit including at least one microprocessor programmed with instructions to execute specific functions.

Hereinafter, a system for controlling creep running of a vehicle and a method thereof according to an exemplary embodiment of the present disclosure is described in detail with reference to the drawings.

### First Exemplary Embodiment

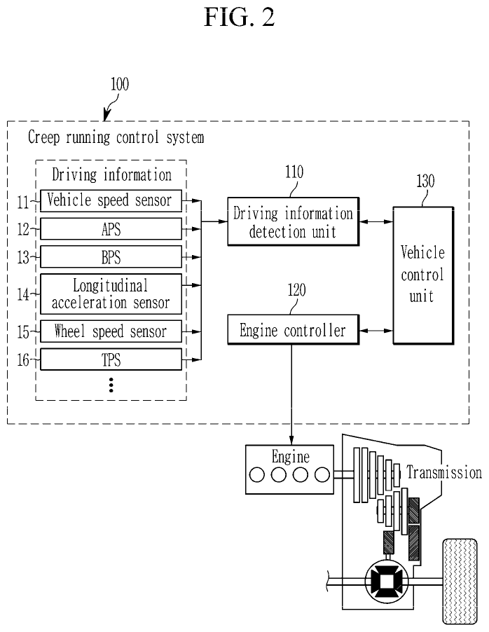

FIG. 2 is a schematic diagram of a system for controlling creep running of a vehicle according to a first exemplary embodiment of the present disclosure.

Referring to FIG. 2, a system 100 for controlling creep running of a vehicle according to a first exemplary embodiment of the present disclosure includes a driving information detection unit 110, an engine controller 120, and a vehicle control unit 130.

A system 100 for controlling creep running of a vehicle may be applied to various types of vehicles such as an internal combustion engine (ICE) vehicle having an ICE, or a hybrid electric vehicle (HEV) utilizing electric power as driving power of a vehicle.

The driving information detecting unit 110 detects driving information required for controlling creep running of the vehicle from various sensors and controllers during running of the vehicle, and transmits the detected driving information to the vehicle control unit 130.

For example, the driving information detection unit 110 may include, a vehicle speed sensor 11, an accelerator pedal sensor (APS) 12, a brake pedal sensor (BPS) 13, a longitudinal acceleration sensor 14, a wheel speed sensor 15, and a transmission position sensor (TPS) 16, and may detect driving information therefrom.

The driving information detection unit 110 may detect a vehicle speed by the vehicle speed sensor 11 or the wheel speed sensor 15, and may transmit the detected vehicle speed to the vehicle control unit 130.

The driving information detection unit 110 may detect a driver's accelerator pedal operation state of by the APS 12 and a brake operation state by the BPS 13, and may transmit the detected information to the vehicle control unit 130.

The driving information detection unit 110 may also detect a longitudinal acceleration of the vehicle by the longitudinal acceleration sensor 14 and a wheel acceleration by the wheel speed sensor 15, and may transmit the detected information to the vehicle control unit 130.

The driving information detection unit 110 may detect transmission position (e.g., shift-ranges such as forward (D) range or reverse (R) range, etc.) by the TPS 16, and may transmit the detected transmission position to the vehicle control unit 130.

The engine controller 120 controls the output torque of the engine, in this example, controls the creep driving torque of the engine, in accordance with a control signal from the vehicle control unit 130. The engine forms a driving torque under the control of the engine controller 120. In the present embodiment, the creep torque of the engine may be varied based on the inclination of the road, and a predetermined creep torque for a horizontal (i.e., un-inclined) road is hereinafter referred to as a basic creep driving torque (or equivalently, basic creep torque).

It may be understood that the engine controller 120 may control the engine to output an additional driving torque based on an inclination of the road inclination, which is described below.

The vehicle control unit 130 may be supervisory controller to perform an overall operation of a creep running control according to an exemplary embodiment of the present disclosure.

When the vehicle speed is below a predetermined speed (e.g., 10 km/h), creep control of the vehicle may be initiated, and the vehicle control unit 130 sends a control signal to the engine controller 120 to force the engine to generate the basic creep driving torque.

When the vehicle is on a sloped road of more than a predetermined inclination, the vehicle control unit 130 controls the engine controller 120 to control the engine to output a modified creep driving torque based on the inclination of the road, such that the vehicle may be effectively moved with the modified creep torque on the sloped road as if the vehicle is moved with the basic creep torque on the horizontal road, which is described in detail below.

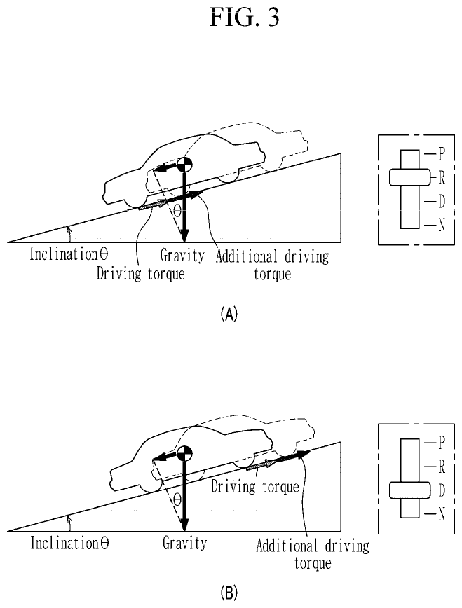

FIG. 3 schematically illustrates controlling creep running of a vehicle on a sloped road according to a first exemplary embodiment of the present disclosure.

FIG. 3(A) illustrates that the vehicle is tried to move upward in the reverse (R) range on a downhill road. In this situation, gravity cancels the basic creep torque at least partially, and thus the vehicle may show effectively less creep torque by a conventional creep control.

According to an exemplary embodiment, the vehicle control unit 130 calculates an additional creep torque depending on the inclination of the downhill road, and controls the engine to output a further creep torque by the additional creep torque, through the engine controller 120. Therefore, the creep running of the vehicle may be controlled to show effectively the same creeping in the reverse range on the downhill sloped road.

In addition, FIG. 3(B) illustrates that the vehicle is tried to move upward in the forward (D) range on an uphill road.

In this situation, vehicle control unit 130 may calculate the additional creep torque depending on the inclination of the uphill road, and may control the engine to output a further creep torque by the additional creep torque, through the engine controller 120. Therefore, the creep running of the vehicle may be controlled to show effectively the same creeping in the forward (D) range on the uphill sloped road.

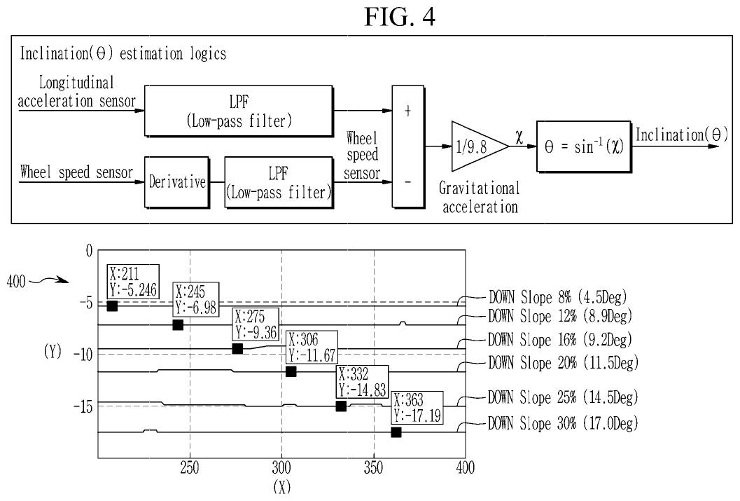

FIG. 4 illustrates a method for estimating a slope according to a first exemplary embodiment of the present disclosure.

Referring to FIG. 4, the vehicle control unit 130 may perform relatively precise estimation of a road inclination θ at a low vehicle speed condition, using the longitudinal acceleration sensor value and the wheel speed sensor value collected by the driving information detection unit 110. For example, when a vehicle is located on a sloped road, the longitudinal acceleration sensor value includes two acceleration components, i.e., one by an actual acceleration of the vehicle along a vehicle driving direction and the other by a gravitational component by the road inclination θ. The vehicle control unit 130 may obtain the actual acceleration of the vehicle by performing differentiation of the wheel speed sensor value and then filtering the differentiation value to remove noise. Then, the vehicle control unit 130 may obtain the estimation of the road inclination θ by subtracting the actual acceleration of the vehicle from the longitudinal acceleration sensor value and then calculating an inverse sin function of the subtracted value.

The vehicle control unit 130 may calculate a minimum creep driving torque corresponding to the road inclination θ based on a basic vehicle mass. Here, the minimum creep driving torque includes a basic creep driving torque for creep running of the vehicle on a flat road and an additional driving torque (hereinafter, called a first additional driving torque) for taking into account of the road inclination θ.

The vehicle control unit 130 may store a control map for the minimum creep driving torque with respect to the road inclination θ based on the basic vehicle mass. Thus, when the road inclination θ is obtained, the vehicle control unit 130 may retrieve an appropriate value of the minimum creep driving torque corresponding to the road inclination θ from the control map, and may generate a corresponding control signal.

FIG. 4 also shows a graph 400 illustrating distance (X) over height (Y) to generate the downward slope.

The basic vehicle mass may be set as a vehicle mass with no occupants or one occupant of a driver. However, it may be understood that the vehicle mass may vary with more occupants or other loads, which may affect the creep running of the vehicle because gravitational component of the vehicle on the sloped road may also be affected thereby. Also, the vehicle control unit 130 may not directly identify a change in the vehicle mass due to more occupants and/or other loads.

In this background, when an actual creep running wheel speed is less than a target creep running wheel speed, the vehicle control unit 130 may generate a further additional driving torque (hereinafter, called a second additional driving torque) to compensate a deviation between actual and target wheel speeds. Thus, by applying a final creep driving torque which is a sum of the minimum creep driving torque and the second additional driving torque, the target creep running wheel speed may be rapidly achieved even if the vehicle of a varied mass is on a sloped road.

In a variation, the vehicle control unit 130 may estimate a change in the vehicle mass based on the signals from the wheel speed sensor 15. The vertical vibration of a wheel of a vehicle is varied when a vehicle mass is varied. Therefore, when a change in a vertical vibration component in frequency domain is obtained and compared with a preset value for a basic vehicle mass, the change in the vehicle mass, e.g., due to more occupants or load, may be obtained. Korean patent publication No. 10-2015-0170977 may be referred to for estimating a change of a vehicle mass based on signals from a wheel speed sensor. Since the vehicle control unit 130 may estimate the vehicle mass change, e.g., a vehicle mass increase with respect to an empty vehicle, the vehicle control unit 130 may calculate a second additional driving torque to compensate a gravitational effect of a vehicle mass increase on the sloped road. Then, the vehicle control unit 130 adds the second additional driving torque to the minimum creep driving torque to form the final creep driving torque, and send a corresponding signal to the engine controller 120.

In response to the control signal corresponding to the final creep driving torque received from the vehicle control unit 130, the engine controller 120 controls the engine to output the final creep driving torque.

In the above description, the vehicle control unit 130 and the engine controller 120 are described as being separate components, however the present disclosure is not limited thereto, since the vehicle control unit 130 and the engine controller 120 may be integrated as a single controller/control unit.

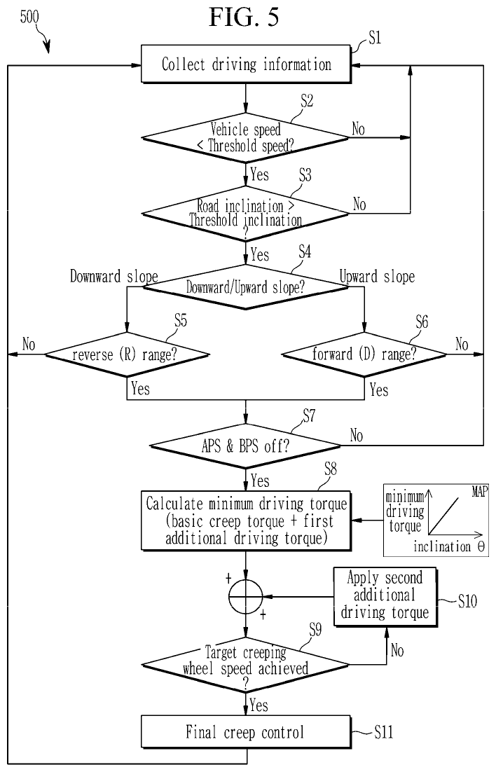

Hereinafter, a method 500 for controlling creep running of a vehicle applicable by the system 100 for controlling creep running of a vehicle is described in detail with reference to FIG. 5. In the description below, although the vehicle control unit 130 is described to control the engine for convenience of description, it may be understood that the vehicle control unit 130 may control the engine through the control controller 120.

FIG. 5 is a flowchart showing a method for controlling creep running of a vehicle according to a first exemplary embodiment of the present disclosure.

At step S1, the vehicle control unit 130 collects driving information of the vehicle from the driving information detection unit 110, during running of the vehicle. The driving information may include a vehicle speed, an APS operation signal, a BPS operation signal, a longitudinal acceleration sensor value, a wheel speed sensor value, and transmission position information such as a forward (D) range or a reverse (R) range.

At step S2, the vehicle control unit 130 determines whether the vehicle speed satisfies a low speed condition, i.e., whether the vehicle speed is less than a threshold vehicle speed (e.g., 10 km/h). When the vehicle speed is less than the threshold vehicle speed (S2—Yes), the vehicle control unit 130 initiates a creep running control, and estimates a road inclination based on the collected longitudinal acceleration sensor value and the wheel speed sensor value. The road inclination may be estimated as described with reference to FIG. 4.

At step S3, the vehicle control unit 130 determines whether the road inclination is above a threshold inclination. At the step S3, an absolute value of the road inclination may be compared with the threshold inclination, since the step S3 is to determine whether the road is sloped more steeply than a predetermined level. When the road inclination is above a threshold inclination (S3—Yes), then subsequently at step S4, the vehicle control unit 130 determines whether the inclination is downward inclination or an upward inclination. The orientation of downward or upward inclination may be determined with respect to a front of a vehicle, which may be represented by positive or negative sing of the estimated road inclination, or vice versa.

At step S5, the vehicle control unit 130 determines whether the transmission position is in the reverse (R) range when the vehicle is on a downward slope of a downward inclination. At step S6, the vehicle control unit 130 determines whether the transmission position is in the forward (D) range when the vehicle is on a upward slope of an upward inclination. When the vehicle is in the reverse (R) range on the downward slope (S5—Yes) or in the forward (D) range on the upward slope (S6—Yes), then at step S7, the vehicle control unit determines checks operation states of the APS and BPS, i.e., whether an off-signal is received from both of the APS and BPS, meaning that a driver does not operate any of the accelerator pedal and the brake pedal.

When both the APS and BPS output the off-signal (S7—Yes), then at step S8, the vehicle control unit 130 calculates a minimum creep driving torque corresponding to the road inclination θ. The minimum creep driving torque may be calculated greater as the road inclination θ is greater. In detail, the minimum creep driving torque may be calculated as a sum of a basic creep driving torque and a first additional driving torque. The basic creep driving torque may be preset as an appropriate torque for creep running of the vehicle on a flat road (i.e., a horizontal road without an inclination), and the first additional driving torque may increase as the road inclination θ increases. The minimum creep driving torque corresponding to the road inclination θ may be retrieved from a preset control map stored in a memory of the vehicle control unit 130, and the control map may be preset based on a basic vehicle mass.

It may be understood that the exemplary illustration of the minimum creep driving torque with respect to the road inclination θ does not necessarily indicate that minimum creep driving torque equals 0 when the road inclination θ equals 0. Instead, the graph of the minimum creep driving torque is plotted with a base of the preset basic creep driving torque so as to illustrate that the minimum creep driving torque may proportionally increase as the road inclination θ increases.

By applying the minimum creep driving torque, the vehicle starts creep running.

At step S9, the vehicle control unit 130 determines whether an actual wheel speed of the vehicle reaches a target creep wheel speed by the minimum creep driving torque. When the target creep wheel speed is achieved by the minimum creep driving torque (S9—Yes), then at step S11, the vehicle control unit 130 determines the minimum creep driving torque as a final creep driving torque and maintains controlling the creep running of the vehicle by the minimum creep driving torque.

When the target creep wheel speed is not achieved by the minimum creep driving torque (S9—No), then at step S10, the vehicle control unit 130 generates a second additional driving torque to compensate a deviation between the actual and target wheel speeds. It may be understood that the target creep wheel speed may not be achieved by the minimum creep driving torque when an actual mass of the vehicle is heavier than as supposed, e.g., by more passengers or loads. Thus, the second additional driving force may minimize the effect of variation of the actual vehicle mass. The second additional driving torque is feedback controlled. That is, the second additional driving torque is fed back to the minimum creep driving torque, and may be further increased until the target creep wheel speed is achieved.

When the target creep wheel speed is achieved by the second additional driving torque added to the minimum creep driving torque (S9—Yes), the vehicle control unit 130 determines the final creep driving torque as the sum of the minimum creep driving torque and the second additional driving torque, at the step S11.

When the vehicle speed does not satisfy the low speed condition (S2—No), or when the road inclination is not above the threshold inclination (S3—No), the creep running condition is not satisfied, and thus a creep running control of the vehicle is not initiated. In this case, the vehicle control unit 130 may proceed to the step S1 and maintain collecting driving information.

As a variation of an embodiment, when the road inclination is not above the threshold inclination (S3—No), the vehicle control unit 130 may proceed to the step S7 such that the basic creep driving torque is applied when the off-signal is received from both of the APS and the BPS. That is, in this variation, the creep running of the vehicle is controlled by the basic creep driving torque preset for the flat road.

In addition, when the vehicle is not in the reverse (R) range on a downward slope (S5—No), or when the vehicle is not in the forward (D) range in an upward slope (S6—No), the vehicle control unit 130 may proceed to the step S1 and maintain collecting driving information.

In another variation of an embodiment, when the vehicle is not in the reverse (R) range on a downward slope (S5—No), or when the vehicle is not in the forward (D) range in an upward slope (S6—No), the vehicle control unit 130 may proceed to the step S7 such that the basic creep driving torque is applied when the off-signal is received from both of the APS and the BPS. That is, in this variation, the creep running of the vehicle is controlled by the basic creep driving torque preset for the flat road when the vehicle is moving downward, i.e., either forward on a downward slope or backward on an upward slope.

When at least one of the APS and BPS signals is not the off-signal at the step S7, the vehicle control unit 130 may proceed to the step S1 and maintain collecting driving information.

The present disclosure is not limited to the above-described first exemplary embodiment, and variations may be available

For example, in the description of the first exemplary embodiment, an engine, more specifically an internal combustion engine is controlled to exert the basic creep driving torque and first and second additional creep driving torques. However, it may be understood that the present disclosure may be applied to another configuration employing other sources of driving power. Exemplary variations employing other power sources of the creep running of the vehicle are hereinafter described.

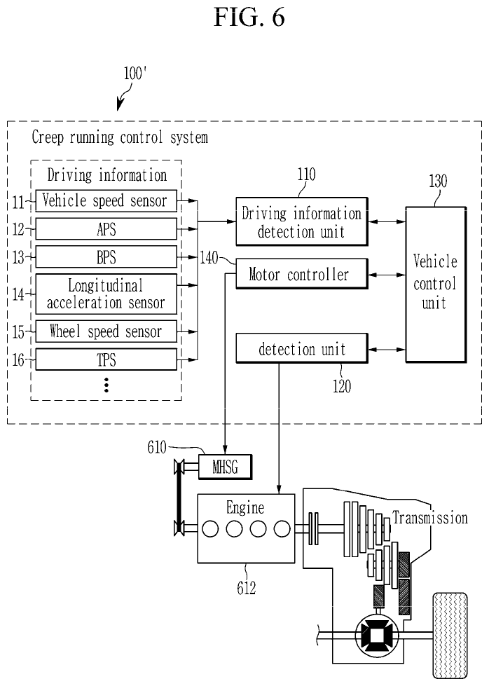

FIG. 6 is a schematic diagram of a system for controlling creep running of a vehicle according to a second exemplary embodiment of the present disclosure.

Referring to FIG. 6, a system 100′ for controlling creep running of a vehicle according to a second exemplary embodiment is applied to a mild hybrid electric vehicle (MHEV) or to a typical hybrid electric vehicle (HEV).

The same as in the first exemplary embodiment, the system 100′ for controlling creep running of a vehicle includes the driving information detection unit 110, the engine controller 120, and the vehicle control unit 130. It is notable that the system 100′ further includes a motor controller 140. The following description will be focused on differences from the first exemplary embodiment.

An MHEV and a HEV have a common feature that both the engine and the motor is utilized as a driving power source of the vehicle. Although the MHEV may not be driven solely by the output of a motor, shown as MHSG 610 in FIG. 6, the motor MHSG 610 may form a driving torque to assist the output torque of the engine 612. Thus, it may be understood that the following description with reference to the MHEV layout of FIG. 6 may also be applicable to a HEV.

The engine controller 120 controls the output torque of the engine 612, in this example, controls a basic creep driving torque of the engine 612, in accordance with a control signal from the vehicle control unit 130.

The motor controller 140 controls the output torque of the motor MHSG 610, in this example, controls an additional driving torque to assist the basic creep driving torque of the engine 612, in accordance with the control signal from the vehicle control unit 130.

That is, in this embodiment, the basic creep driving torque is output from the engine and the first and second additional driving torques are output from the motor MHSG 610, in comparison with the first exemplary embodiment where the basic creep driving torque and the first and second additional driving torques are output from the engine.

Since other features remain the same as in the first exemplary embodiment, it may be understood that the exemplary method described with reference to FIG. 5 may also be applied to the present embodiment.

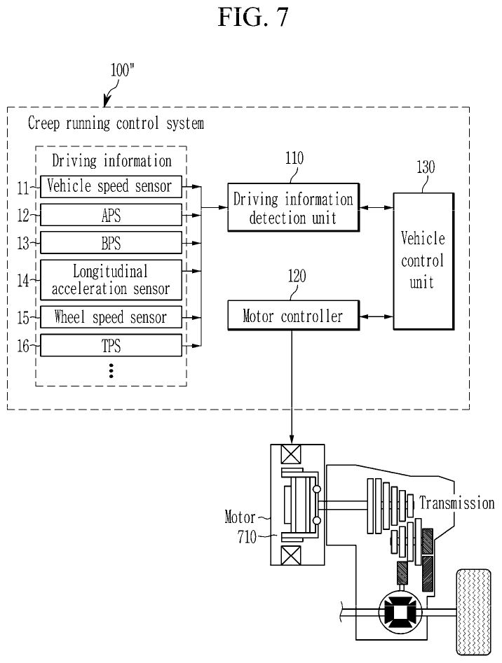

FIG. 7 is a schematic diagram of a system for controlling creep running of a vehicle according to a third exemplary embodiment of the present disclosure.

Referring to FIG. 7, a system 100″ for controlling creep running of a vehicle according to a third exemplary embodiment is applied to an electric vehicle (EV) or to a hybrid electric vehicle (HEV).

The same as in the first exemplary embodiment, a system 100″ for controlling creep running of a vehicle includes the driving information detection unit 110 and the vehicle control unit 130. It is notable that the engine controller 120 of the first exemplary embodiment is replaced with a motor controller 140 in this embodiment. The following description will be focused on differences from the first exemplary embodiment.

It may be understood that the present embodiment may be applied to a HEV that may be driven by an output torque of an employed motor 710.

The motor controller 140 controls the output torque of the motor 710, in this example, controls a basic creep driving torque of the motor 710, in accordance with a control signal from the vehicle control unit 130.

Furthermore, the motor controller 140 controls the output torque of the motor 710 to further output an additional driving torque in accordance with the control signal from the vehicle control unit 130.

That is, in this embodiment, the basic creep driving torque and the first and second additional driving torques are output from the motor 710, in comparison with the first exemplary embodiment where the basic creep driving torque and the first and second additional driving torques are output from the engine 612.

Since other features remain the same as in the first exemplary embodiment, it may be understood that the exemplary method described with reference to FIG. 5 may also be applied to the present embodiment.

According to the embodiment of the present disclosure, even if the vehicle is located on a sloped road, a low speed creep running similar to a vehicle being on a flat road may be achieved.

Since the vehicle may show a creep running on the sloped road similarly to the flat road, convenience in driving the vehicle at a low speed may be achieved, e.g., in the case of moving the vehicle back and forth in parking.

The exemplary embodiment is not limited to be implemented only by the aforementioned apparatus and/or method, and may be implemented by a program for operating a function corresponding to the configuration of the exemplary embodiment, a recording medium in which the program is recorded, and the like, and the implementation may be easily realized from the description of the aforementioned exemplary embodiment by those skilled in the art.

The description of the different advantageous arrangements has been presented for purposes of illustration and description, and is not intended to be exhaustive or limited to the embodiments in the form disclosed. Many modifications and variations will be apparent to those of ordinary skill in the art, and, the present disclosure is intended to cover various modifications and equivalent arrangements included within the spirit and scope of the appended claims.

What is claimed is:

1. A system for controlling creep running of a vehicle equipped with an engine and a transmission, the system comprising:
a driving information detection unit detecting driving information of the vehicle;
an engine controller for controlling an output torque of the engine; and
a vehicle control unit controlling the engine controller to output a basic creep driving torque, and when the vehicle is on a sloped road of more than a predetermined inclination, to further output a first additional driving torque corresponding to an inclination of the sloped road.

2. The system of claim 1, wherein the driving information detection unit comprises a vehicle speed sensor, an accelerator pedal sensor (APS), a brake pedal sensor (BPS), a longitudinal acceleration sensor, a wheel speed sensor, and a transmission position sensor (TPS).

3. The system of claim 1, wherein the engine controller is configured to control the engine to output the basic creep driving torque and to further output the first additional driving torque.

4. The system of claim 1, wherein the vehicle control unit calculates the first additional driving torque corresponding to the inclination of the sloped road when the transmission is in a reverse range while the vehicle is on a downward slope or when the transmission is in a forward range on an upward slope.

5. The system of claim 4, wherein the vehicle control unit estimates the road inclination based on a longitudinal acceleration sensor value and a differentiation of a wheel speed sensor value.

6. The system of claim 5, wherein the vehicle control unit estimates the road inclination by calculating a wheel acceleration by the differentiation of a wheel speed sensor value, subtracting the wheel acceleration from the longitudinal acceleration sensor value, and then taking an inverse trigonometric function of the subtracted value.

7. The system of claim 1, wherein the vehicle control unit calculates a minimum creep driving torque as a sum of the basic creep driving torque and the first additional driving torque corresponding to the road inclination, and controls the engine controller to output a final creep driving torque of at least the minimum creep driving torque.

8. The system of claim 7, wherein the minimum creep driving torque is retrieved from a predetermined control map preset with respect to the road inclination based on a basic vehicle mass.

9. The system of claim 7, wherein, when a target creep running wheel speed is not achieved by the minimum creep driving torque, the vehicle control unit increases the final creep driving torque by feeding back a second additional driving torque.

10. The system of claim 7, wherein the vehicle control unit calculates a second additional driving torque to compensate a gravitational effect of a vehicle mass increase on the sloped road, and adds the second additional driving torque to the minimum creep driving torque to form the final creep driving torque.

11. A method for controlling creep running of a vehicle equipped with an engine and a transmission, the method comprising:
determining a low speed condition of a vehicle speed being less than a threshold vehicle speed;
determining a road inclination condition of whether a road inclination is above a threshold inclination;
determining a transmission position condition of whether the vehicle is in the reverse (R) range on a downward slope or whether the vehicle is in the forward (D) range in an upward slope;
determining a pedal condition of whether an off-signal is received from both an accelerator pedal sensor (APS) and a brake pedal sensor (BPS);
calculating a minimum creep driving torque as a sum of a basic creep driving torque for creep driving of the vehicle on a flat road and a first additional driving torque corresponding to the road inclination, in the case that the low speed condition, the road inclination condition, the transmission position condition, and the pedal condition are met; and
controlling the engine to output a final creep driving torque that is at least the minimum creep driving torque.

12. The method of claim 11, wherein the road inclination is estimated based on a longitudinal acceleration sensor value and a differentiation of a wheel speed sensor value.

13. The method of claim 11, wherein when the transmission position condition is not satisfied, the creep running of the vehicle is controlled by the basic creep driving torque.

14. The method of claim 11, wherein the calculation of the minimum creep driving torque is performed by retrieving a value corresponding to the road inclination from a predetermined control map.

15. The method of claim 11, further comprising:
determining whether a target creep wheel speed is achieved by the minimum creep driving torque; and
maintaining the minimum creep driving torque as the final creep driving torque, when the target creep wheel speed is achieved by the minimum creep driving torque.

16. The method of claim 11, further comprising:
determining whether a target creep wheel speed is achieved by the minimum creep driving torque; and
if the target creep wheel speed is not achieved, controlling the final creep driving torque by feeding back a second additional driving torque to the minimum creep driving torque, until the target creep wheel speed is not achieved.

17. A system for controlling creep running of a vehicle equipped with an engine, a motor, and a transmission, the system comprising:
a driving information detection unit detecting driving information of the vehicle;
an engine controller for controlling an output torque of the engine;
a motor controller for controlling an output torque of the motor; and
a vehicle control unit controlling the engine controller to output a basic creep driving torque, and when the vehicle is on a sloped road of more than a predetermined inclination, controlling the motor controller to output a first additional driving torque corresponding to an inclination of the sloped road.

18. The system of claim 17, wherein the vehicle control unit controls the engine controller and the motor controller to form a final creep driving torque comprising a sum of the basic creep driving torque of the engine, the first additional driving torque of the motor taking into account the road inclination, and a second additional driving torque of the motor taking into account a vehicle mass variation.

19. A system for controlling creep running of a vehicle equipped with a motor and a transmission, the system comprising:
a driving information detection unit detecting driving information of the vehicle;
a motor controller for controlling an output torque of the motor; and
a vehicle control unit controlling the motor controller to output a basic creep driving torque, and when the vehicle is on a sloped road of more than a predetermined inclination, to further output a first additional driving torque corresponding to an inclination of the sloped road.

20. The system of claim 19, wherein the vehicle control unit controls the motor controller to output a final creep driving torque formed as a sum of the basic creep driving torque of the motor, the first additional driving torque of the motor taking into account the road inclination, and a second additional driving torque taking into account a vehicle mass variation.
